(19) United States
(12) Patent Application Publication
(10) Pub. No.: US 2025/0124419 A1
(43) Pub. Date: Apr. 17, 2025

(54) Secure Peer-to-Peer Payment Platform with Escrow and Dispute Resolution

(71) Applicant: Rolando Penaranda, Little Ferry, NJ (US)

(72) Inventor: Rolando Penaranda, Little Ferry, NJ (US)

(21) Appl. No.: 18/487,084

(22) Filed: Oct. 15, 2023

(51) Int. Cl. G06Q 20/22; G06Q 20/08

(52) U.S. Cl. CPC G06Q 20/223; G06Q 20/0855

(57) ABSTRACT

In some embodiments thereof, the present invention discloses systems and methods for facilitating secure peer-to-peer transactions between a buyer and seller using an intelligent escrow service. In one aspect, transactions are initiated on the platform specifying transaction details. Funds are held in a temporary escrow account and released upon fulfillment of transaction terms. In one aspect, the escrow amount may be dynamically determined using predictive algorithms analyzing factors like user profiles, location, and transaction history. Upon delivery confirmation by the buyer, funds are released to the seller as fulfillment is validated. In one aspect, mediation services using trained machine learning algorithms aid dispute resolution by processing details of issues to provide recommended solutions. The platform provides end-to-end transaction security tailored for direct P2P payments, enhancing trust and accountability without third-party intermediaries. By leveraging artificial intelligence and machine learning capabilities, the invention uniquely combines escrow services, transaction protection, and intelligent dispute resolution for frictionless P2P transactions.

### FIELD OF INVENTION

The present invention relates to the field of secure peer-to-peer (P2P) online payment transactions. The invention provides methods and systems to enable direct payments between buyers and sellers while enhancing trust, safety, and accountability through escrow services, dispute mediation, and transaction protection mechanisms tailored for P2P engagement. In some aspects, it may leverage technologies like blockchain, AI, and analytics to address core challenges like fraud, lack of oversight, and absence of recourse.

### BACKGROUND OF THE INVENTION

The peer-to-peer online transactions industry has grown rapidly in recent years, enabling direct transactions between buyers and sellers without traditional intermediaries. However, this emerging marketplace faces several key challenges that can undermine user trust and experience. One major issue is fraud, as the anonymity and lack of oversight in P2P transactions creates opportunities for scammers and fraudulent activities. Additionally, many users lack confidence when dealing with strangers online, as there is uncertainty regarding whether the other party will fulfill their side of the transaction. The absence of a trusted intermediary or escrow service further contributes to this sense of risk and lack of trust. Disputes frequently arise regarding delivery of goods/services and release of payments, with no clear resolution process.

Another critical challenge is the lack of effective payment protection mechanisms and recourse. Traditional payment systems and methods were not designed for P2P transactions, leaving both parties vulnerable. Buyers may send payments but receive nothing in return, while sellers have no guarantees they will be paid after shipping items or providing services. This absence of payment security and accountability leaves many users reluctant to engage in P2P commerce and marketplaces.

Currently, there is a strong need within the P2P marketplace for solutions that can enhance trust, safety, and accountability for transactions. End-users seek assurances that their funds and information will be protected when dealing with strangers online. Robust identity verification, escrow services, mediation for disputes, and transaction protection systems tailored for P2P engagement would inspire greater confidence among end-users and drive adoption of P2P marketplaces. By leveraging emerging technologies such as artificial intelligence, advanced analytics, and even blockchain, there are significant opportunities to innovate and provide the layers of security and fraud prevention that P2P transactions require. Companies that can effectively address these core challenges will be well-positioned to unlock the full potential of peer-to-peer online transactions.

### SUMMARY OF THE INVENTION

The following summary outlines the key innovations embodied in the system, method, devices, and apparatus described herein. It is important to note that this summary provides a concise overview of the invention's core features without intending to impose limitations beyond the scope defined by the detailed description and claims.

In some embodiments thereof, the present invention discloses systems and methods for secure peer-to-peer (P2P) online payment transactions through an intelligent escrow service. In one embodiment, buyers and sellers initiate P2P transactions by specifying transaction details on the platform, including payment amount, currency, delivery address, etc. Funds are held in a temporary escrow account managed by the platform until the transaction is successfully completed. In one aspect, it is disclosed the use of machine learning algorithms to dynamically determine optimal escrow amounts for each transaction based on analysis of factors such as user profiles, locations, transaction history, and other relevant data.

In one aspect, upon confirmation of delivery/services by the buyer, the funds are released from escrow and paid out to the seller, thereby validating fulfillment. It is further provided a mediation system powered by trained machine learning algorithms that aids in dispute resolution by processing details of issues to generate recommended solutions. By leveraging artificial intelligence capabilities, the platform provides enhanced security, fraud prevention, and accountability measures tailored for P2P transactions without third party intermediaries.

In a non-limiting embodiment, key benefits over current art include reduced risks from fraudulent transactions, increased trust between transacting parties, and efficient mechanisms for resolving issues and disputes. The invented techniques mitigate the lack of oversight and recourse mechanisms that have hindered mainstream P2P transaction adoption.

The invention has significant applications in the P2P payments industry, equipping online payment apps, marketplaces, e-commerce sites and other platforms with the capabilities required for secure direct transactions between buyers and sellers. By combining artificial intelligence-based escrow management, transaction protection, and intelligent dispute resolution, the invention fulfills the need for greater trust, safety, and functionality in P2P online transactions.

### BRIEF DESCRIPTION OF THE DRAWINGS

The novel features believed to be characteristic of the illustrative embodiments are set forth in the appended claims. The illustrative embodiments, as well as a preferred mode of use, will best be understood by reference to the following detailed description when read in conjunction with the accompanying drawings, wherein:

FIG. 1 of the drawings illustrates a system drawing according to one embodiment.

FIG. 2 of the drawings shows a buyer opening a received package containing damaged goods according one embodiment.

FIG. 3 illustrates a user interface provided for submitting documents for resolving disputes by the escrow service according to one embodiment.

FIG. 4 of the drawings demonstrates a resolution service according to one embodiment.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

In this disclosure, the terms AI/ML may be used interchangeably to mean artificial intelligence or machine learning or both

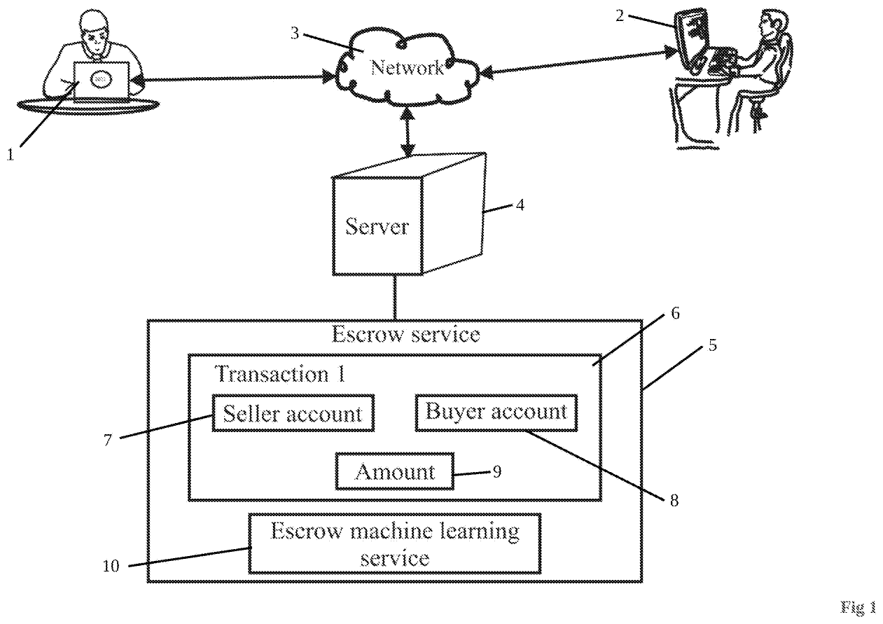

In the first illustrated embodiment according to FIG. 1, is an embodiment of a system for facilitating secure peer-to-peer (P2P) online payment transactions utilizing an escrow service. The exemplary system comprises a buyer device 1, a seller device 2, a network 3, a transaction processing server 4 with an integrated escrow service 5, and a transaction 6 maintained by the escrow service.

In one instance, the buyer device 1 and seller device 2 can communicate over the network 3 with the transaction processing server 4 in order to initiate, manage, and finalize the transaction 6. The network 3 may be any suitable communications network such as the Internet, LAN, WAN, wireless network, or a proprietary network.

In one instance, the transaction processing server 4 provides the core functionality of processing and managing transactions between the buyer device 1 and seller device 2. Uniquely, the server 4 has an escrow service 5 integrated into its transaction processing capabilities. This escrow service 5 acts as an intermediary to hold funds for a transaction 6 in pending status until the transaction terms are fulfilled between the transacting parties.

The transaction 6 may comprises of data regarding a seller account 7, buyer account 8, and transaction amount 9 that is held by the escrow service 5. By storing the transaction data and amount in pending state, the escrow service 5 protects both parties from issues like fraud and non-delivery that can occur in P2P transactions without a trusted intermediary.

To illustrate, in a typical transaction flow, the buyer 1 and seller 2 connect over the network 3 to the transaction server 4 to initiate the transaction 6, which is maintained in pending status by the escrow service 5. Upon the buyer 1 confirming satisfactory delivery/services, the escrow service 5 completes the transaction by releasing the funds to the seller's account 7.

The demonstrated system architecture provides an advantageous solution for securing P2P payments by integrating the protective capabilities of an escrow intermediary with the transaction processing functions necessary for online payments.

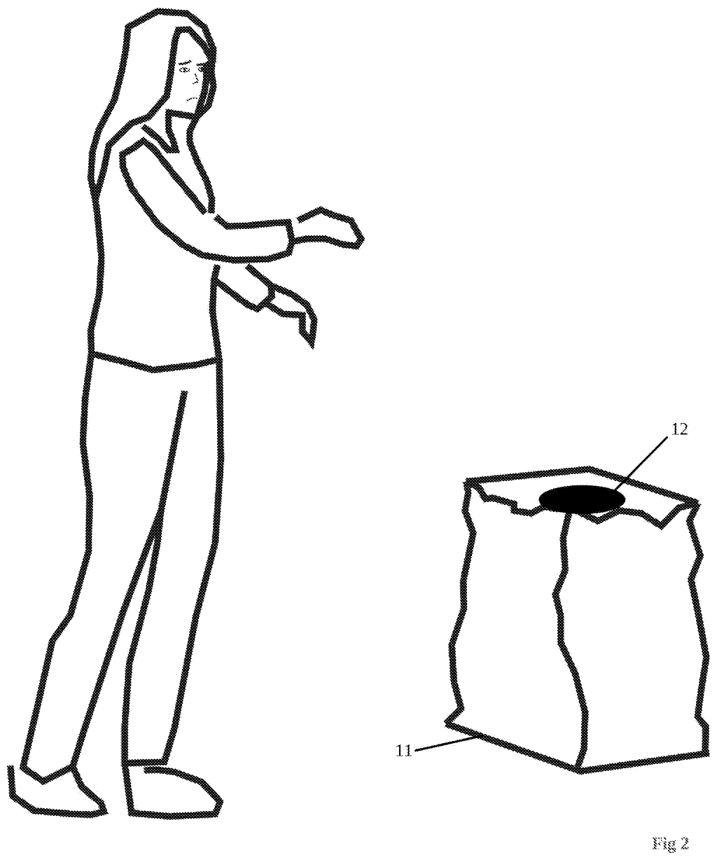

Now making reference to FIG. 2, it is illustrated an embodiment of the invention depicting a transaction dispute scenario where the buyer receives damaged or defective goods. As shown, the figure features a buyer 100 who has received a package 11 containing goods 12 purchased through a peer-to-peer online transaction.

Upon opening the package 11 and inspecting the goods 12, the buyer 100 identifies that the received items are damaged, different from what was agreed upon with the seller, or otherwise unsatisfactory. For example, the goods may be a consumer product or item that was intended to be in new, working condition based on the transaction agreement between the buyer 100 and seller. However, the buyer finds that the product is scratched, cracked, malfunctioning, or not matched what was pictured or described by the seller.

In this dispute scenario, the buyer 100 can leverage the dispute resolution mechanisms provided by the transaction processing platform to mediate the issue and prevent loss of funds. As the transaction is conducted via the platform, an escrow service integrated with the processing system holds the committed funds in pending state throughout the transaction lifecycle.

Therefore, in this embodiment, the funds would remain safely on hold with the escrow service based on the unsatisfactory delivery of goods. The buyer 100 can file a dispute claim to the transaction platform, providing details of the damage, defects, or differences from the agreed upon order. An AI/ML-powered dispute resolution system can then analyze the claim data along with the transaction history and details to determine a fair resolution, preventing the release of funds until the issue is settled between the buyer 100 and seller.

This embodiment illustrates how the escrow and dispute resolution capabilities within the invented platform protect transacting parties, providing recourse in situations of unsatisfactory deliveries and preventing fraudulent transactions. The buyer is able to securely receive compensation or replacement without risk of losing funds already committed to the seller.

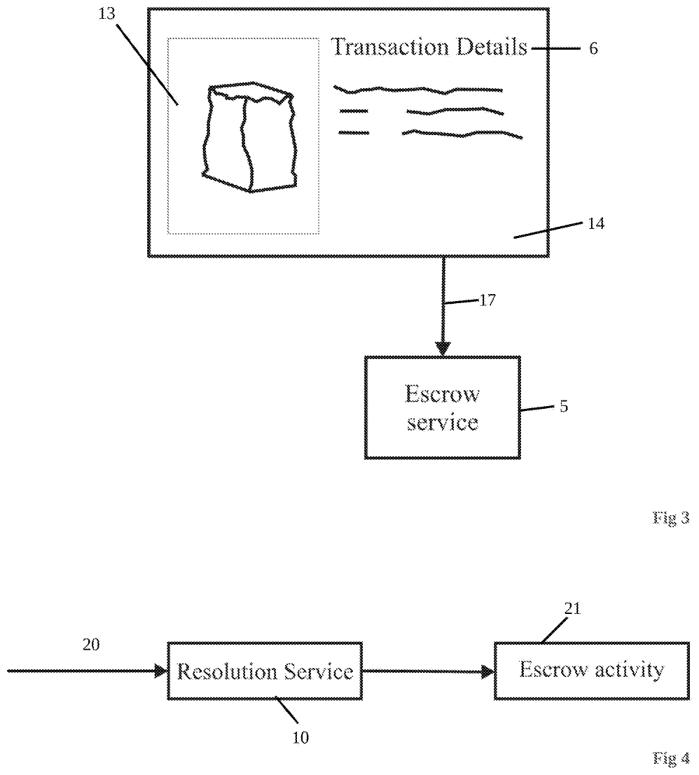

The embodiment according to FIG. 3 illustrates a user interface embodiment for submitting dispute evidence and documents to the escrow service of the transaction platform. As depicted, the user interface 14 displays details of the transaction 6, including seller account, buyer account, and transaction amount.

This interface 14 may be provided to users (buyers or sellers) that need to submit documents to support a dispute claim related to the transaction 6. For example, the buyer may need to provide photos/videos of the defective or damaged goods received as shown in FIG. 2.

The user interface 14 allows the transaction users to upload files 15 or other data communication that contains evidence related to the dispute. This may include digital photos, scanned documents, videos, audio, or other multimedia that demonstrates the grounds for dispute. The submitted dispute documents 15 are sent to the integrated escrow service 5 as data transmissions.

The escrow service 5, managing the transaction 6 in pending state, can then utilize the dispute documents 15 along with relevant transaction history to determine a resolution. The documents strengthen the dispute claim and provide the escrow service 5 greater context when analyzing the issue through its AI/ML capabilities. By providing this dedicated interface 14 for submitting dispute evidence, the platform makes it straightforward for transacting parties to initiate mediation and file claims over unsatisfactory transactions. The escrow service 5 is able to incorporate rich evidence like photos, videos, and documents to arrive at fair dispute resolutions, improving accountability in P2P transactions.

A further reference is made to FIG. 4 of the drawings, which illustrates an embodiment of the dispute resolution capabilities provided by the escrow service's integrated machine learning system. This AI/ML-powered resolution service 10 receives data inputs 20 containing evidence and details related to a disputed transaction, analyzes the information, and determines recommended courses of action.

The data input 20 can include digital photos, scanned documents, videos, audio files, or other multimedia submitted by the transacting parties to back up their dispute claim. This evidence provides critical context that enhances the resolution service's 10 ability to parse dispute details and establish fair outcomes. In some aspects, a hybrid type dispute resolution service 10 may be applied, where integrated machine learning not only resolves disputes and make the decision, but may also help human agents in making decisions in more complicated dispute cases through recommendation of a variety of resolves.

The resolution service 10 may leverage supervised (or unsupervised) machine learning algorithms and models that have been trained on prior historical transactions and dispute cases. The models are trained by inputting detailed data on past transaction features and dispute scenarios, along with the ideal target outcomes decided in those cases. By learning from these prior examples, the algorithms develop predictive capabilities for modeling new dispute scenarios.

For training data, the system is fed details from thousands of transactions, both successful and disputed. Dispute training data includes the multimedia evidence files, transaction logs, participant communications, and ultimately the resolution reached. This teaches the algorithms the correlations between evidence, transaction details, and optimal dispute resolutions.

Once suitably trained, the machine learning models may intake new dispute evidence and transaction data, analyze the variables, recall similar patterns from its training, and predict fair outcomes. The algorithms output a recommended resolution, forecasting how the case would be decided based on past precedent.

In some aspect, possible machine learning approaches include convolutional neural networks for processing multimedia evidence, recurrent networks for analyzing sequential logs and communications, and regression methods for predicting dispute outcomes. The models output a percentage likelihood estimate across different actions, like refunding the buyer a certain amount, requesting the seller to replace the item, releasing payment to the seller if no fault is found, among others.

As such, by leveraging AI techniques trained on historical transaction data, the resolution service 10 provides an optimized and consistent approach to dispute resolution. The escrow service 5 can rely on data-driven recommendations to inform its mediation decisions, improving accountability while limiting manual oversight needed for P2P transaction disputes.

In a non-limiting aspect, it may be provided for the escrow service the use of a machine learning regression model to dynamically determine optimal escrow amounts for transactions. The model may trained on historical transaction data to analyze the relationship between transaction details and ideal escrow amounts.

In one aspect, the training data may incorporate features such as buyer and seller profiles, reputation scores, location, transaction category, item information, price, and other relevant variables. For example, the training data may incorporate transaction details like amounts and timestamps, user profiles with information such as transaction history and verification status, dispute information including evidence provided by the parties, behavioral data points, external data sources, feedback and ratings, support tickets, and more. The target variable that the model trains to predict may be the optimal escrow amount, customized as a percentage of the transaction rather than a fixed rate.

The training data, may also be categorized and weighted such that certain categories may carry more weight than others, for example:

Transaction Data may include: Transaction amount, Timestamp of the transaction, Payment method used, Transaction ID. User Profiles may include: User ID, Transaction history (e.g., frequency, amounts, types of transactions), Dispute history (number of previous disputes, outcomes), Account age, Verification status (e.g., phone verified, email verified, ID uploaded). Dispute Details may include: Reason for dispute (e.g., not received, not as described, unauthorized transaction), Timestamp of when the dispute was raised, Dispute description and evidence provided by both parties, Communication records between parties.

Behavioral Data may include: Response time to messages or inquiries, Login patterns, Frequency of disputes compared to transactions. External Data may include: IP addresses and geolocation data to track suspicious activity or mismatches, Device information (browser, OS, device type). Feedback/Rating System data may include: Ratings provided by other users, Comments or feedback from past transactions.

Support Tickets data may include: Past support tickets or inquiries raised by the user, The nature of previous tickets (e.g., technical issues, payment issues, misunderstandings). Attachment Analysis data may include: If users can attach evidence, use image or document analysis to check for authenticity, detect possible tampering, and correlate data. Natural Language Processing (NLP) may: Analyze communication between parties for sentiment, urgency, or indicators of dishonesty. Pattern Recognition may include: Look for patterns in disputes—e.g., if a user repeatedly raises the same type of dispute or if certain types of transactions are more prone to disputes.

Social Media and Web Presence may: If a user links their social profiles, analyze their activity or reputation for any potential red flags. Historical Data may: Compare the current dispute with historical data on similar disputes and their outcomes. Economic Indicators may: In case of large amounts, consider economic factors such as currency exchange rates, or local economic conditions.

Tracking Number data may: validates whether an item was shipped, be used to determine the status of the shipment (e.g., in transit, delivered, returned), help establish a timeline of events, especially useful in cases where a buyer claims they never received an item. Package Weight data may: validate whether the package's weight matches the expected weight of the item, help in cases where the item received was not as described, or the box was empty; determine if multiple items were shipped together, which can be relevant in cases involving bulk purchases.

Shipping Provider and Service Level data may: determine providers known for better reliability compared to others; know which provider and service level (e.g., standard, express, overnight) was used can give context to the dispute, indicate the expected delivery timeline, helping judge if a delay claim is reasonable. Delivery Confirmation data may: provide a key piece of evidence in disputes about whether an item was received. Shipping Cost and Insurance data may: determine how much was paid for shipping and whether insurance was purchased, providing insights into the perceived value and importance of the shipped item by the sender; determine if insurance was claimed, it could also be evidence in the dispute.

Return/Refund Policy Information data may: provide clarity on expected procedures for returns or refund requests; help judge if a return/refund dispute adheres to agreed terms. Photos of Packaged Item may: establish evidence of condition at time of shipping for comparison against damage claims. Receipts or Invoices data may: align expectations about contents by providing itemized documentation of what was meant to be shipped.

Product/Service Description data may: allow assessing inconsistencies by comprehensively documenting characteristics of product/service. Price Comparison data may: identify anomalies or potential fraud by contrasting transaction price against averages for similar items. Terms of Agreement data may: supersede assumptions by legally binding both parties to contracted terms if available. Duration of Escrow may: signify expected timeframe by revealing planned escrow period.

User Behavior Post-Transaction data may: imply dissatisfaction, unease or fraudulent intent through abnormal actions. Referral Source data may: reveal useful behavioral insights by understanding user acquisition channels.

Payment Gateway Details data may: enable tracking transactions issues through provider and identifiers. Frequency of Communication data may: indicate relationship quality based on extent of contact between parties. Multi-Factor Authentication Events data may: identify access anomalies by logging security challenges during transaction.

Historical Dispute Ratios may: suggest problematic users based on their prior dispute rates. External Reviews or Ratings data may: provide comprehensive reputation profile by incorporating third-party data. Billing and Shipping Address Consistency data may: detect fraud by comparing against user profile for changes. Categorical Analysis may: uncover dispute tendencies that vary across product/service categories. Custom Feedback from Escrow Agents data may: capture nuances through human insights that augment automated systems.

Currency & Banking Details data may: raise red flags by detecting sudden account or currency changes. Platform Usage Patterns data may: reveal motivations by analyzing how users interact with the platform.

By learning on thousands of transaction examples, the regression model may detect patterns and correlations that are used to predict tailored escrow amounts. Transactions involving new users, expensive items, higher risk locations, etc. will warrant higher or absolute escrow percentages, while reputable frequent transactors will require lower escrow amounts.

In a non-limiting aspect, for any new transaction, the model may input the transaction features and profiles of the parties involved to output a custom escrow percentage recommendation. This dynamic and data-driven approach maximizes efficiency of capital held in escrow, while still providing adequate transaction protection.

In some aspects, the machine learning integration also enables the escrow service to continually improve over time as more transaction data is accumulated. The model may be retrained on new data, allowing the escrow percentage predictions to be refined and optimized continuously.

In some aspects, the regression approach described above for predicting customized escrow amounts is one possible machine learning technique, however other algorithms can also be utilized for this prediction task. For example, tree-based models like random forests or gradient boosted trees could also be trained on the transaction data to output escrow amount recommendations. Similarly, clustering algorithms such as K-means could segment transactions into risk clusters associated with certain escrow ranges. Neural network architectures are also capable of learning complex escrow amount prediction functions from the transaction data features.

The innovative system for facilitating secure peer-to-peer transactions through an escrow service can be implemented in multiple architectural forms, including standalone systems or distributed platforms.

In a standalone architecture, the escrow management, dispute resolution, and transaction processing functionalities are handled locally on buyer and seller devices. This provides simplicity but may limit scalability.

Conversely, a distributed implementation offloads the analysis workloads onto remote servers. Buyer/seller devices transmit transaction data to centralized servers that run the escrow service, dispute algorithms, etc. before returning instructions. This allows aggregating data from many users.

The optimal implementation depends on factors like real-time needs, data volumes, and security. A proprietary system may favor standalone, while a third-party marketplace benefits from distributed architecture.

The escrow invention can manifest as methods, systems, or computer programs that blend hardware and software capabilities. The key steps can be enabled via executable instructions that direct processors to perform the novel secure transaction functions. These instructions are encapsulated in media like storage devices or memory.

Experts may identify variations, additions, or substitutions aligned with the goal of enhancing P2P transaction security. Reasonable modifications are intended to be covered within the spirit and scope of this invention. Use of singular or plural terms should be interpreted expansively based on context. In summary, the applicant seeks to cover integrations that advance the core objective of combining escrow protections and intelligent dispute resolution for frictionless P2P transactions.

### INDUSTRIAL APPLICATION

The invention described herein finds significant industrial application in the peer-to-peer online payments sector by providing an improved system for secure transactions directly between buyers and sellers. The intelligent integration of escrow services, dispute resolution, and transaction protection mechanisms solves key challenges holding back widespread adoption of P2P payments. By reducing risks of fraud and lack of accountability, the invention promotes trust in P2P engagement. The invented techniques can be incorporated by payment apps, marketplaces, and e-commerce platforms to upgrade security and expand P2P transaction capabilities at scale.

What is claimed is:

1. A payment system comprising:
a. an escrow service adapted to hold funds for a transaction between a buyer and a seller; and
b. a machine learning model trained to analyze transaction data to determine when conditions of the transaction are met:
wherein the escrow service is configured to release funds to the seller
when the machine learning model determines the conditions are met.

2. The system of claim 1, wherein the escrow service is configured to hold the funds in a temporary escrow account.

3. The system of claim 1, wherein the conditions comprise the buyer confirming satisfactory receipt of goods or services.

4. The system of claim 1, wherein the machine learning model utilizes historical transaction data for training.

5. The system of claim 1, further comprising a dispute resolution component powered by the machine learning model.

6. The system of claim 1, wherein the escrow service is configured to determine a dynamic escrow amount using a predictive algorithm.

7. The system of claim 6, wherein the dynamic escrow amount is based on details of the transaction and profiles of the buyer and seller.

8. A computer-implemented method for facilitating transactions, comprising:
a. receiving transaction details from a buyer and a seller;
b. determining an escrow amount to hold for the transaction based on the transaction details;
c. holding the escrow amount until conditions of the transaction are determined to be met using a machine learning model; and
d. releasing the escrow amount to the seller upon the conditions being met.

9. The method of claim 8, further comprising verifying identities of the buyer and seller.

10. The method of claim 8, wherein the conditions comprise receiving confirmation from the buyer that goods or services were received satisfactorily.

11. The method of claim 8, further comprising using a dispute resolution service enabled by the machine learning model in response to an issue with the transaction.

12. The method of claim 8, wherein determining the escrow amount comprises using a predictive algorithm to dynamically calculate the escrow amount based on details of the transaction.

13. The method of claim 12, wherein the predictive algorithm analyzes profiles of the buyer and seller.

14. The method of claim 8, wherein the machine learning model is trained on historical transaction data.

15. The method of claim 8, further comprising continually retraining the machine learning model as new transaction data is received.

16. A computer program product comprising a non-transitory computer readable medium storing instructions that when executed by a processor perform a method comprising:
a. receiving transaction details from a buyer and a seller;
b. determining an escrow amount to hold for the transaction based on the transaction details;
c. holding the escrow amount until conditions of the transaction are determined to be met using a machine learning model; and
d. releasing the escrow amount to the seller upon the conditions being met.

17. The computer program product of claim 1, wherein the method further comprises using a dispute resolution service enabled by the machine learning model in response to an issue with the transaction.

18. The computer program product of claim 1, wherein determining the escrow amount comprises using a predictive algorithm to dynamically calculate the escrow amount based on details of the transaction and profiles of the buyer and seller.

19. The computer program product of claim 1, wherein the machine learning model is trained on historical transaction data and continually retrained as new transaction data is received.

20. The computer program product of claim 1, wherein the conditions comprise receiving confirmation from the buyer that goods or services were received satisfactorily.
